(19) United States
(12) Patent Application Publication
(10) Pub. No.: US 2010/0087169 A1
(43) Pub. Date: Apr. 8, 2010

(54) THREADING TOGETHER MESSAGES WITH MULTIPLE COMMON PARTICIPANTS

(75) Inventors: Hsuan-Yu Jerry Lin, Seattle, WA (US); Kenneth Q. Sabotta, Seattle, WA (US); Paul A. Mailman, Billerica, MA (US); Gerardo Garcia, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/480,969

(22) Filed: Jun. 9, 2009

Related U.S. Application Data
(63) Continuation-in-part of application No. 12/244,545, filed on Oct. 2, 2008.

(51) Int. Cl. H04L 12/58

(52) U.S. Cl. 455/412.1

(57) ABSTRACT

In a mobile communications device, a conversation identifier is generated for each of a plurality of messages. Each conversation identifier is generated based on addresses of message participants identified in the message. A request to display a particular message of the multiple messages is received. In response to the request, one or more other messages of the plurality of messages having a same conversation identifier as the particular message are identified based on the generated conversation identifiers. At least two of the one or more other messages are displayed concurrently.

### RELATED APPLICATIONS

This application is a continuation-in-part of U.S. patent application Ser. No. 12/244,545, filed Oct. 2, 2008, titled “Inter-threading Indications of Different Types of Communication” to Hsuan-Yu Jerry Lin, et al., which is hereby incorporated by reference herein.

### BACKGROUND

Mobile communications devices, such as wireless phones, have become increasingly commonplace. Mobile communications devices typically support different types of communications, such as text messages or messages with other types of content. Although users can typically send and receive these different types of communications using their mobile communications devices, it is oftentimes difficult for users to keep track of the communications being sent and received from multiple parties. This in turn can result in frustrating user experiences when using the mobile communications devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a mobile communications device a conversation identifier is generated for each message of a plurality of messages. A request to display a particular message of the plurality of messages is received. In response to the request, one or more other messages of the plurality of messages having a same conversation identifier as the particular message are identified based on the generated conversation identifiers. At least two of the one or more other messages of the plurality of messages are displayed concurrently.

In accordance with one or more aspects, in a mobile communications device a message is obtained. From the message, addresses of a plurality of participants identified in the message are obtained. Based on these addresses obtained from the message, a conversation identifier for the message is generated.

### BRIEF DESCRIPTION OF THE DRAWINGS

The same numbers are used throughout the drawings to reference like features.

FIG. 1 illustrates an example system implementing the threading together messages with multiple common participants in accordance with one or more embodiments.

FIG. 2 illustrates an example display of messages from multiple participants threaded together in accordance with one or more embodiments.

FIG. 3 illustrates another example display of messages from multiple participants threaded together in accordance with one or more embodiments.

FIG. 4 is a flowchart illustrating an example process for implementing the threading together messages with multiple common participants in accordance with one or more embodiments.

FIG. 5 is a flowchart illustrating an example process for generating a conversation identifier in accordance with one or more embodiments.

FIG. 6 is a flowchart illustrating an example process for generating a conversation identifier in accordance with one or more embodiments.

FIG. 7 illustrates an example device that can be configured to implement the threading together messages with multiple common participants in accordance with one or more embodiments.

### DETAILED DESCRIPTION

Threading together messages with multiple common participants is discussed herein. Messages having numerous participants can be sent, and received, by a mobile communications device. Messages having a common set of participants are threaded together and identified as being part of the same conversation. This identification is performed by generating a conversation identifier based on the message participants. Accordingly, the messages can be displayed by the mobile communications device as being threaded together and part of the same conversation.

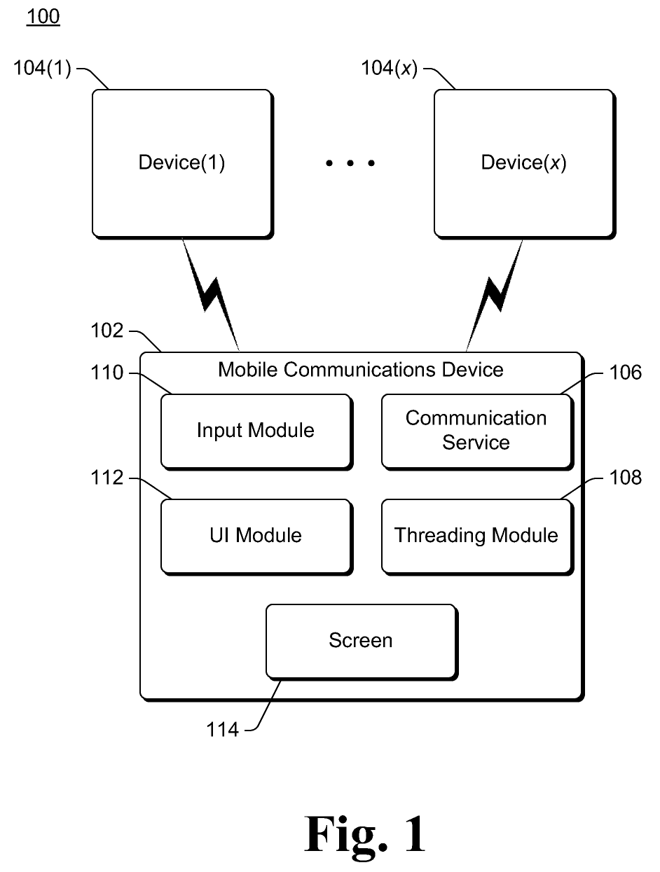

FIG. 1 illustrates an example system 100 implementing the threading together messages with multiple common participants in accordance with one or more embodiments. System 100 includes a mobile communications device 102 that can communicate with one or more (x) other devices 104(1), . . . , 104(x). A mobile communications device refers to a communications device capable of sending and receiving communications, such as phone calls, text messages, messages including other content types, and so forth. Communications device 102 is referred to as being mobile, as it is typically designed to be moved and used in different locations by users. Mobile communications device 102 can be a variety of different types of devices, such as a cellular phone, a satellite phone, other types of wireless phones, a handheld computer, a personal digital assistant (PDA), an audio and/or video playback device, a portable game device, an automotive computer, a dedicated messaging device, a netbook, and so forth. It is to be appreciated that mobile communications device 102 can include functionality in addition to being able to send and receive communications calls, such as calendar functionality, audio and/or video playback functionality, and so forth.

Devices 104 can be, but need not be, mobile communications devices. Devices 104 can be the same type or alternatively different types of devices as mobile communications device 102.

Mobile communications device 102 includes a communication service 106, a threading module 108, an input module 110, a user interface (UI) module 112, and a screen 1 14. Each of communication service 106 and modules 108, 110, and 112 can be implemented in software, firmware, hardware, or combinations thereof. When implemented in software or firmware, a module includes one or more instructions that are executed by one or more processors or controllers of mobile communications device 102.

Screen 114 is a display component of mobile communications device 102. Screen 114 can be implemented in a variety of different manners, such as using liquid crystal display (LCD) technology, plasma screen technology, image projection technology, and so forth. Alternatively, rather than including screen 114, mobile communications device 102 can generate one or more signals that are output to other display devices which include screen 114.

Communication service 106 manages receiving of communications from and sending of communications to devices 104. Mobile communications device 102 can communicate with devices 104 using a variety of different technologies and protocols, such as cellular, satellite, and/or other technologies or protocols. The technologies or protocols can include wireless and/or wired technologies and protocols.

Communication service 106 supports a variety of different types of communications with devices 104. One type of communication typically supported by communication service 106 is a voice call. This can include voice calls that are initiated by mobile communications device 102 (e.g., outgoing calls), as well as voice calls that are initiated by another device 104 (e.g., incoming calls). Alternatively, mobile communications device 102 can support other types of communications, and need not support voice calls.

Another type of communication supported by communication service 106 is a message, which refers to text messages or messages with other types of media such as images, video, audio, combinations of types of media, and so forth. In one or more embodiments, messages comply with the Short Message Service (SMS) communication protocol. In one or more other embodiments, messages comply with the Multimedia Messaging Service (MMS) communication protocol. It is to be appreciated that SMS and MMS are only example protocols, and that other communication protocols can alternatively be used. Various other types of communications can also be supported by communication service 106, such as mobile instant messaging (mobile IM), email (electronic mail), and so forth.

In one or more embodiments, communication service 106 can also communicate with one or more social networking services using a variety of different networks, including the Internet, a local area network (LAN), a public telephone network, an intranet, a cellular or other wireless phone network, other public and/or proprietary networks, combinations thereof, and so forth. Communication service 106 obtains data regarding various individuals or other entities using social networking services.

Communication service 106 can obtain data from a social networking service directly or via an intermediary data service. Communication service 106 provides an indication to the social networking service (or intermediary data service) of one or more individuals or other entities for which data is desired. These individuals or other entities can be, for example, individuals in a local address book of device 102. Individuals or other entities can publish a variety of different data regarding themselves on a social networking service, and communication service 106 can obtain this data from the social networking service. Examples of such published information include phone numbers (e.g., a mobile phone number, a home phone number, a work phone number, and so forth), email addresses, instant messaging addresses, postal mailing addresses, images or videos, images or videos that both the user of device 102 and the individual or entity are tagged in, a social feed (e.g., indicating a current location of, or activity engaged in by, the individual or other entity), profile details (e.g., an individual's relationship status, birthday, interests or hobbies, and so forth), upcoming meetings or events that both the user of device 102 and individual or entity are to be part of, friends of the individual or entity, and so forth.

A social networking service can also send messages to mobile communications device 102 on behalf of users of the social networking service. These messages can be sent using a variety of different communication protocols and types of communication as discussed above.

Input module 110 receives user inputs from a user of mobile communications device 102. User inputs can be provided in a variety of different manners, such as by pressing one or more keys of a keypad or keyboard of device 102, or pressing a particular portion of a touchpad or touchscreen of device 102. Touchscreen functionality can be provided using a variety of different technologies, such as through capacitive, surface acoustic wave, resistive, optical, strain gauge, dispersive signals, acoustic pulse, or other touchscreen technologies. The user input can also be provided in other manners, such as via audible inputs, other physical feedback input to the device (e.g., tapping any portion of device 102 or another action that can be recognized by a motion detection component of device 102, such as shaking device 102, rotating device 102, etc.), and so forth.

UI module 112 generates, manages, and/or outputs a user interface for display on screen 114. This user interface displays various information on screen 114, and user inputs can be received by input module 110 as discussed above. UI module 112 can display, for example, messages sent by mobile communications device 102 to other devices 104, as well as messages received by mobile communications device 102 from other devices 104.

Messages that mobile communications device 102 sends to devices 104 (also referred to as outgoing messages) can have multiple recipients. Accordingly, outgoing messages can have three or more participants to the message: the sender (device 102) as well as multiple recipients (devices 104). Similarly, messages that mobile communications device 102 receives from devices 104 (also referred to as incoming messages) can have multiple recipients. Accordingly, incoming messages can also have three or more participants to the message: the sender (a device 104) as well as multiple recipients (device 102 as well as one or more other devices 104). The participants can refer to the devices 102, 104 themselves, or alternatively the users of the devices as discussed in more detail below. Threading module 108 identifies the participants involved in incoming messages and outgoing messages, and groups together messages that involve the same participants as discussed in more detail below. UI module 112 can use this grouping information to display together (also referred to as threading) messages that threading module 108 groups together as discussed in more detail below.

Messages can originate with mobile communications device 102 and be sent to devices 104, or can originate with a device 104 and be sent to device 102 as well as one or more other devices 104. Each message includes, for the sender of the message and each recipient of the message, a participant identifier. These participant identifiers are used to generate a conversation identifier for the message. Different messages that have the same participant identifiers will have the same conversation identifier, and thus can be grouped or threaded together when displayed by UI module 112.

In one or more embodiments, the participant identifier is an identifier of a user of the device 102 or 104. Users are associated with different user identifiers that allow different users to be distinguished from one another. These user identifiers can be GUIDs (Globally Unique Identifiers), or alternatively can be other identifiers. Each user can have multiple different phone numbers, email addresses, mobile IM addresses, and/or other addresses that he or she uses. These different phone numbers, email addresses, mobile IM addresses, and/or other addresses of a user are associated with the user identifier of that user. Accordingly, when a message includes one of these phone numbers, email addresses, mobile IM addresses, and/or other addresses, the user identifier associated with the message can be readily determined and used as a participant identifier. This determination can be repeated for each sender and recipient to obtain the participant identifiers of the sender and all the recipients of the message. Alternatively, mobile communications device 102 can be aware of the participant identifier of device 102, and such determination need not be made for the user of device 102.

The different phone numbers, email addresses, mobile IM addresses, and/or other addresses associated with a particular user identifier can be determined in a variety of different manners. In one or more embodiments, a database of users is accessed by threading module 108 (or alternatively another component or module of mobile communications device 102). This database can be a database maintained locally by device 102 (e.g., a local address book or contacts list), or alternatively can be maintained on a remote device or service. The database includes a different record for each user. Each record has a record identifier and also includes the different phone numbers, email addresses, mobile IM addresses, and/or other addresses that that user uses. Accordingly, given a particular phone number or address, the record including that phone number or address can be readily identified, and the record identifier for that record can also be readily identified. The record identifier can then be used as the user identifier for that user.

In other embodiments, rather than being an identifier of a user of the device 102 or 104, the participant identifier is an identifier of an address of the device 102 or 104. In one or more embodiments, the address of a device is a phone number of the device, an email address of the device, or a mobile IM address of the device. Such addresses can be programmed into the devices 102 and 104, such as in response to configuration inputs by a user of the devices 102 and 104, by a reseller when a device 102 or 104 is purchased, and so forth. Additionally, such addresses can optionally be stored on a removable card or other storage component that can be transferred to different devices.

Although a participant identifier can be an identifier of a device, in such situations the participant identifier can still be associated with a name of a user of the device (also referred to as a participant name). A record or database that associates users with participant identifiers can be maintained, and this record can be accessed to determine the name of the user associated with that participant identifier. This name can then be displayed when messages from that user's device are received, as discussed in more detail below. The record that is maintained can be, for example, a local address book or contacts list maintained by the mobile communications device, a remote address or phone book service, and so forth.

The threading together messages with multiple common participants is discussed herein primarily with reference to generating a conversation identifier based on phone numbers, email addresses, and/or mobile IM addresses. It is to be appreciated however, that conversation identifiers can also be generated based at least in part on various other addresses. For example, these addresses can be addresses or other identifiers provided by another service (such as a social networking service) but that are associated with the participant. By way of another example, these addresses can be addresses that are assigned and/or modified by an intermediary or other service or device.

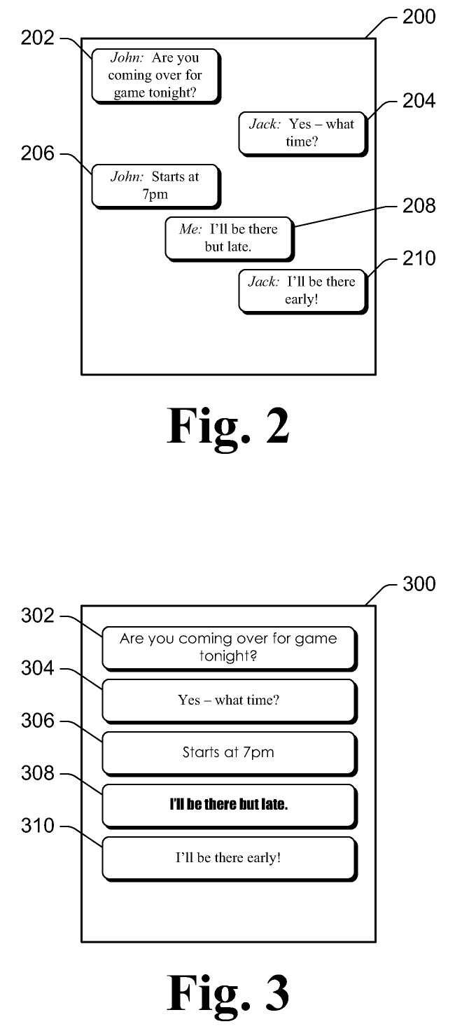

FIG. 2 illustrates an example display of messages from multiple participants threaded together in accordance with one or more embodiments. Messages are displayed on a screen 200 in chronological order based on when the messages are received or sent. Messages sent or received earlier can be displayed above (or alternatively below) messages that are subsequently sent or received.

The messages 202, 204, 206, 208, and 210 displayed in the example of FIG. 2 are arranged in columns, with the left column being associated with a first participant, the middle column associated with a second participant, and the right column being associated with a third participant. Each message includes an indication of the participant that sent the message. In the example of FIG. 2, a participant named “John” was the sender of messages 202 and 206, a participant named “Jack” was the sender of messages 204 and 210, and the user of the mobile communications device displaying the messages is the sender of message 208.

In one or more embodiment, a different column is used for each different sender of a message. For example, if there are five participants in a message, then five columns of messages are displayed. Alternatively, the messages can be arranged in fewer columns (or more columns) than there are participants in the message. Columns can be overlapping as illustrated in FIG. 2, or alternatively can be non-overlapping.

The mobile communications device is aware of the messages it sends, and accordingly can readily identify the user of the device as the sender of those messages. The name of the sender of a message received from another device can be determined in different manners. In one or more embodiments, the name of the sender of a message received from another device is included in the message received by the mobile communications device. The name can have been included in the message by the sender, or alternatively by an intermediary. In other embodiments, the mobile communications device can determine the participant identifier as discussed above. The mobile communications device can then use the participant identifier to look up the name of the user having that participant identifier based on a record that associates users with participant identifiers as discussed above. For example, assume the participant identifier is a phone number. An incoming message includes the phone number of the sender of the message, and the mobile communications device can access its local contacts list to identify the user associated with that phone number (e.g., “Jack”), and display that user's name when the message is displayed. By way of another example, assume the participant identifier is a user identifier. An incoming message includes an address that is used to determine the user identifier as discussed above, and the database that provides the user identifier based on the address can also provide the name of the user associated with that user identifier.

Alternatively, rather than including the participant names in the messages, the participant names can be displayed elsewhere. For example, a column heading can be displayed to identify the participant name of messages in that column, the participant name can be displayed when a user touches or taps a message (or hovers over a message) with his or her finger or a stylus, and so forth.

In other embodiments, messages from different users are associated with different display characteristics. Examples of such different display characteristics include different font types, different font sizes, different font colors, different highlighting or background colors, different background patterns, and so forth.

FIG. 3 illustrates another example display of messages from multiple participants threaded together in accordance with one or more embodiments. Messages are displayed on a screen 300 in chronological order based on when the messages are received or sent, analogous to screen 200 of FIG. 2.

The messages 302, 304, 306, 308, and 310 displayed in the example of FIG. 3 are arranged in a single column. However, different font types are used for different participants. In the example of FIG. 3, a first participant was the sender of messages 302 and 306, a second participant was the sender of messages 304 and 310, and a third participant was the sender of message 308. Alternatively, the participant names can be displayed in the messages, or otherwise displayed as discussed above with reference to FIG. 2.

It is to be appreciated that the example displays shown in FIGS. 2 and 3 are examples, and that messages can be displayed threaded together in a variety of different manners. These differences can include different columns or other display arrangements, different display characteristics, and so forth. Furthermore, it is to be appreciated that additional information can be displayed with the messages. For example, a date and/or time that the message was received or sent can be displayed. By way of another example, pictures or other information associated with the participants can be displayed, such as pictures of the participants, pictures published by the participants via a social networking service and obtained by the mobile communications device from the social networking service, and so forth.

Returning to FIG. 1, threading module 108 generates a conversation identifier for a message that is based on the participant identifiers for that message. In one or more embodiments, threading module 108 generates the conversation identifier for a message when the message is received at or sent by mobile communications device 102. Alternatively, the conversation identifier for a message can be generated at different times, such as when a user request to display the message is received, when a processor of mobile communications device 102 has available bandwidth, and so forth.

Once a conversation identifier for a message is generated by mobile communications device 102, device 102 can store the conversation identifier for subsequent reference rather than re-calculating the conversation identifier. The conversation identifier can be stored in different manners. In one or more embodiments, the conversation identifier is added to the message when stored internally by mobile communications device 102. In other embodiments, each message can have a message identifier, and a record associating message identifiers with conversation identifiers is maintained. This record can then be accessed when the conversation identifier for a message is desired.

Alternatively, the conversation identifier need not be stored by mobile communications device 102. Rather, device 102 can re-calculate the conversation identifier when needed.

In other alternatives, mobile communications device 102 can maintain different areas or portions where messages with different conversation identifiers are stored. These different areas or portions can be, for example, different tables, different directories in a file system, and so forth. Accordingly, once a conversation identifier for a message is generated, the message can be stored in the appropriate area for that conversation identifier. Separate conversation identifiers generated for the different messages stored in that area need not be maintained, as the message being stored in that area inherently associates with the message the conversation identifier for that area.

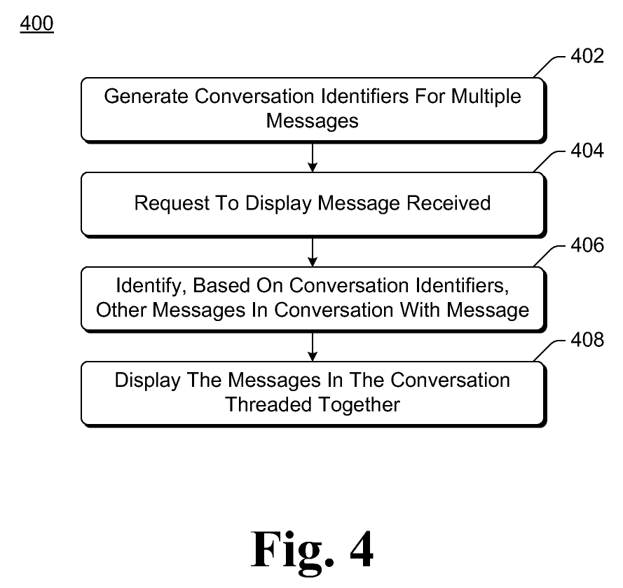

FIG. 4 is a flowchart illustrating an example process 400 for implementing the threading together messages with multiple common participants in accordance with one or more embodiments. Process 400 is carried out by a mobile communications device, such as a device 102 of FIG. 1, and can be implemented in software, firmware, hardware, or combinations thereof. Process 400 is an example process for threading together messages with multiple common participants; additional discussions of threading together messages with multiple common participants are included herein with reference to different figures.

In process 400, conversation identifiers for multiple messages are generated (act 402). In one or more embodiments, a conversation identifier is generated for a message when the message is received (or sent) by the device implementing process 400. Alternatively, the conversation identifier can be generated at other times, such as in response to a request from another component or module, when a processor of the device implementing process 400 has available bandwidth, and so forth.

Eventually, a request to display a message is received (act 404). This request can be a user request input by a user in a variety of different manners as discussed above. A variety of different user requests can be received in act 404, such as a user request to display recent messages, a user request to display a particular message, a user request to display a most recently received message, a user request to display messages having particular participants (e.g., as selected from an address book or contact list of the user), and so forth. Alternatively, this request can be a request received from another component or module.

In response to the request and based on the conversation identifiers generated in act 402, other messages in the same conversation as the message are identified (act 406). Messages are treated as being in the same conversation if they have the same conversation identifiers.

The messages identified in act 406 as being in the conversation are displayed threaded together (act 408). This displaying includes displaying two or more of the messages concurrently. These messages can be displayed in a variety of different manners to facilitate identifying which participant sent which message as discussed above. Furthermore, if the number of messages identified in act 406 exceed a number that can be displayed on a screen of the device implementing process at a time, then the user optionally scroll the display of the screen (e.g., scroll up and/or down) to display additional messages.

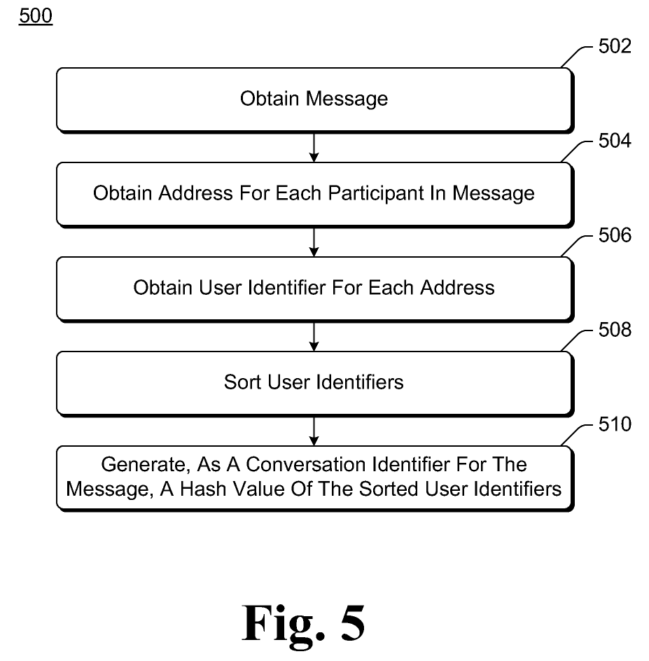

FIG. 5 is a flowchart illustrating an example process 500 for generating a conversation identifier in accordance with one or more embodiments. Process 500 is carried out by a mobile communications device, such as a device 102 of FIG. 1, and can be implemented in software, firmware, hardware, or combinations thereof. Process 500 is an example process for generating a conversation identifier; additional discussions of generating a conversation identifier are included herein with reference to different figures.

In process 500, a conversation identifier is generated based on participant identifiers that are user identifiers. These user identifiers can be generated in a variety of different manners as discussed above. Additionally, as the user identifiers are generated based on the addresses obtained from the message, the participant identifiers in process 500 can also be referred to as being based on these addresses in the message.

In process 500, a message is obtained by the threading module (act 502). This obtained message can be an outgoing message or an incoming message.

An address for each participant in the message is also obtained (act 504). These addresses are included as part of the message as discussed above.

A user identifier is obtained for each address (act 506). The user identifier can be obtained in a variety of different manners, such as by accessing a database of users as discussed above.

The user identifiers obtained in act 506 are then sorted (act 508), resulting in a set of sorted user identifiers. The user identifiers are sorted in a variety of different manners according to one or more criteria, such as in numerical ascending order or numerical descending order. Alternatively, the user identifiers can be sorted according to a variety of other rules and/or criteria.

The sorted user identifiers are concatenated together and a hash value of the sorted user identifiers is generated (act 510). This hash value is used as the conversation identifier for the message. This hash value can be generated using a variety of different hash functions, including both cryptographic or one-way hash functions, non-cryptographic hash functions, and so forth. Examples of such hash functions include the MD5 (Message-Digest algorithm 5) hash function, the SHA-1 (Secure Hash Algorithm 1) hash function, and so forth.

Alternatively, rather than using a hash function, the conversation identifier of the message can be generated in different manners. For example, the sorted user identifiers can be concatenated together, and the concatenated user identifiers can be used as the conversation identifier.

In process 500, the conversation identifier is described as being generated based on the user identifiers of each participant in the message. Alternatively, the user identifier of the user of the mobile communications device that is implementing process 500 need not be included in the conversation identifier. A mobile communications device generates conversation identifiers for the messages it sends and receives (e.g., for conversations that it is part of). Accordingly, the device can exclude the user identifier of the user of that device because that device knows that the messages it sends and receives include the user identifier of its own user as a participant.

Additionally, in process 500, the user identifiers are sorted in act 508. By sorting the user identifiers, process 500 ensures that conversation identifiers for messages having the same participants are the same even though the order in which those participants may be listed in the message is different. Alternatively, rather than sorting the user identifiers, other actions can be taken to ensure that the same conversation identifiers are generated in such situations. For example, rather than generating a single conversation identifier, a different conversation identifier can be generated for each possible ordering of participants in the message. This group of different conversation identifiers can be maintained and used as the conversation identifier for the message. If two messages have groups of conversation identifiers, and at least one of the conversation identifiers in those two groups is the same, then the two messages can be treated as being part of the same conversation.

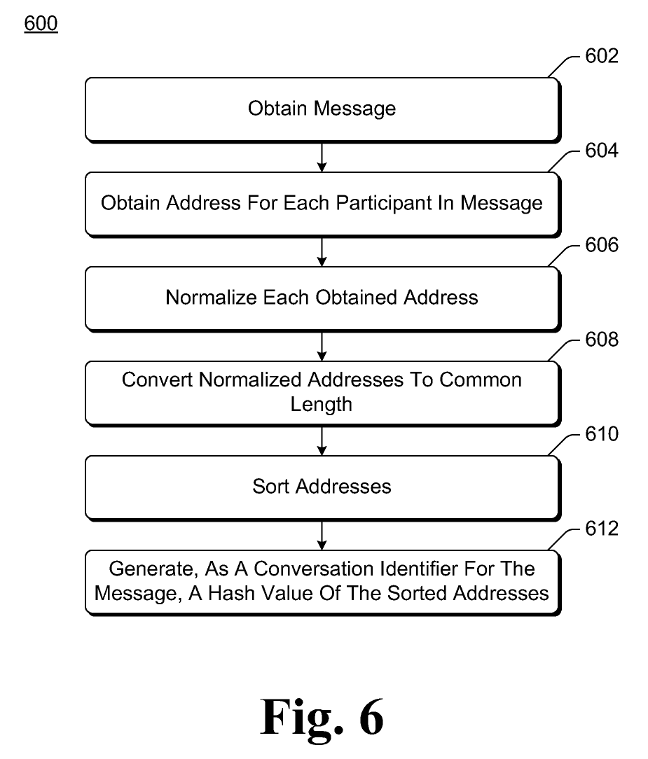

FIG. 6 is a flowchart illustrating an example process 600 for generating a conversation identifier in accordance with one or more embodiments. Process 600 is carried out by a mobile communications device, such as a device 102 of FIG. 1, and can be implemented in software, firmware, hardware, or combinations thereof. Process 600 is an example process for generating a conversation identifier; additional discussions of generating a conversation identifier are included herein with reference to different figures.

In process 600, a conversation identifier is generated based on participant identifiers that are addresses of a device. These addresses can be, for example, phone numbers, email addresses, and/or mobile IM addresses as discussed above. Alternatively, other addresses can be used.

In process 600, a message is obtained by the threading module (act 602). This obtained message can be an outgoing message or an incoming message.

An address for each participant in the message is also obtained (act 604). These addresses are included as part of the message as discussed above.

Each address that is obtained in act 604 is normalized (act 606), resulting in a set of normalized addresses. The normalization of an address refers to converting the address to a representation that is consistent regardless of the manner in which users or networks store or otherwise refer to the address. This can include adding characters to, removing characters from, and/or changing characters in the address.

In one or more embodiments, an address that is a phone number is normalized by identifying a significant number of digits in the phone number. This significant number of digits is typically the tail digits of the phone number taken in a particular order (e.g., taken in reverse order, taken in forward order, etc.). Other non-digit characters or spaces in the phone number are excluded from the normalized phone number. The significant number of digits can vary by locale, and a record of this significant number is maintained for each locale. This record can be maintained in the mobile communications device itself (e.g., having been added to the device by the device manufacturer or reseller), or alternatively can be maintained on a remote service or device.

For example, assume that for a particular locale the significant number of digits is ten, and the digits are taken in a reverse order. If the address were the phone number (425) 555-1234, then the normalized address would be 4321555524. If the message were to list the phone number as 4255551234 or 1-425-555-1234, the normalized address for these different manners of representing the phone number would still result in a normalized address of 4321555524.

In other embodiments, different techniques for normalizing the address are used. For example, different orderings of the digits can be used. By way of another example, particular characters (such as hyphens, parentheses, spaces, etc.), can be left in, and if a phone number does not have those particular characters then the particular characters can be added to the phone number as part of the normalization process.

In one or more embodiments, an address that is an email address is normalized by removing any whitespace from the address and converting the letters in the email address to lower case (or alternatively upper case) letters. Whitespace in an email address refers to spaces in the email address (e.g., spaces following or preceding the non-space characters of the email address).

It should be noted that situations can arise where the normalization of an address need not be performed in act 606. For example, the address may already be in the normalized form (e.g., an email address with no whitespace and in lower-case letters), in which case no normalization need be performed. By way of another example, the device implementing process 600 may receive messages from a particular service or carrier, and can further be aware of the format in which addresses are received from that service or carrier. This format can be used as the normalized format, in which case no normalization need be performed.

Each normalized address is converted to a common length (act 608), resulting in a set of converted addresses. This common length is, for example, a length that is equal to the output length of a hash value by a particular hash function, as discussed in more detail below. In one or more embodiments, a normalized address is converted to a common length by generating a hash value for the normalized address by applying a hash function to the normalized address. A variety of different hash functions can be used, including both cryptographic or one-way hash functions, non-cryptographic hash functions, and so forth. Examples of such hash functions include the MD5 hash function, the SHA-1 hash function, and so forth.

Alternatively, the normalized address can be converted to a common length in other manners. The hash function generates a hash value having a particular length, such as 128 bits (which is used as the common length in act 608). This particular length can be used as a threshold length. If the characters in a normalized address can be converted to their ASCII (American Standard Code for Information Interchange) values (which are 8 bits per character), and the string of ASCII values is equal to or less than the threshold length, then a string of these ASCII values can be used as the rather than generating a hash value for the normalized address. If the string of ASCII values is less than the threshold length, then additional characters can optionally be added to the string to bring the string to the threshold length (e.g., the string can be filled at the end with zeroes or ones, the ASCII values from the beginning of the string can be repeated, and so forth). Alternatively, other public and/or proprietary encodings can be used in place of ASCII values.

For example, assume that a normalized address is 4321555524. This normalized address is 10 digits long, and each digit can be represented using the 8-bit ASCII value for that digit. Accordingly, the normalized address 4321555524 would be represented as a string of 10 8-bit ASCII values, for a total string length of 80 bits. This string can be elongated to become 128 bits by adding 48 additional bits to the end of the string, such as by adding 48 zero (“0”) bits, by adding 48 one (“1”) bits, by adding the ASCII values for the digits 432155, or other manners.

It should be noted that situations can arise where the conversion of a normalized address to a common length need not be performed in act 608. For example, if all of the addresses obtained in act 604 are less than a particular length (e.g., 128 bits), then the conversion in act 608 need not be performed.

The set of converted addresses from act 608 is then sorted (act 610), resulting in a set of sorted addresses. The addresses are sorted in a variety of different manners according to one or more criteria, such as in numerical ascending order or numerical descending order. Alternatively, the addresses can be sorted according to a variety of other rules and/or criteria.

The sorted addresses are concatenated together and a hash value of the sorted addresses is generated (act 612). This hash value is used as the conversation identifier for the message. This hash value can be generated using a variety of different hash functions as discussed above with reference to act 608. The hash value in act 612 can be generated using the same hash function as was used in act 608, or alternatively can be generated using a different hash function.

Alternatively, rather than using a hash function, the conversation identifier of the message can be generated in different manners. For example, the sorted addresses can be concatenated together, and the concatenated addresses can be used as the conversation identifier.

In process 600, the conversation identifier is described as being generated based on the addresses of each participant in the message. Alternatively, the address of the mobile communications device that is implementing process 600 need not be included in the conversation identifier. A mobile communications device generates conversation identifiers for the messages it sends and receives (e.g., for conversations that it is part of). Accordingly, the device can exclude its own address because that device knows that the messages it sends and receives include its own address.

Additionally, in process 600, the converted normalized addresses are sorted in act 610. By sorting the addresses, process 600 ensures that conversation identifiers for messages having the same participants are the same even though the order in which those participants may be listed in the message is different. Alternatively, rather than sorting the converted normalized addresses, other actions can be taken to ensure that the same conversation identifiers are generated in such situations. For example, rather than generating a single conversation identifier, a different conversation identifier can be generated for each possible ordering of participants in the message. This group of different conversation identifiers can be maintained and used as the conversation identifier for the message. If two messages have groups of conversation identifiers, and at least one of the conversation identifiers in those two groups is the same, then the two messages can be treated as being part of the same conversation.

Accordingly, it can be seen that the techniques discussed herein allow messages with common participants to be threaded together. This provides a conversation-type feel to messages with common participants due to the messages sent by the various participants being displayed together. Furthermore, the messages are threaded together based on a conversation identifier that is generated by the device generating the UI that displays the messages. Accordingly, no centralized service or device need be used to assign the conversation identifier; rather, each mobile communications device can generate its own conversation identifier.

Furthermore, it is to be appreciated that a mobile communications device can generate conversation identifiers and display messages with common participants threaded together regardless of whether other devices do the same. As discussed above, the conversation identifiers are generated by the mobile communications device based on the addresses in the messages the device sends and/or receives. One mobile communications device's ability to display messages with common participants together does not affect any other mobile communications device's ability to do so.

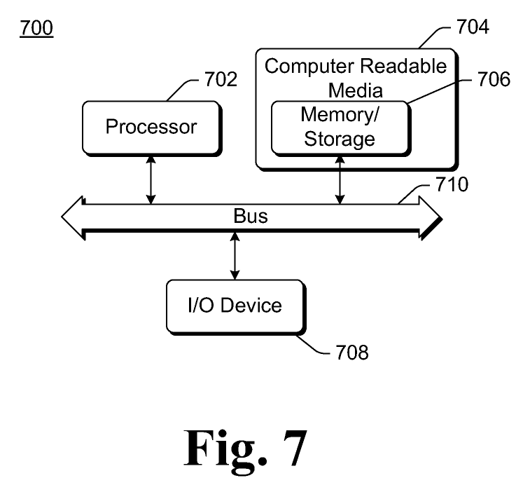

FIG. 7 illustrates an example device 700 that can be configured to implement the threading together messages with multiple common participants in accordance with one or more embodiments. Device 700 can be, for example, a mobile communications device 102 of FIG. 1.

Device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, device 700. Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. It is to be appreciated that different instructions can be stored in different components of device 700, such as in a processing unit 702, in various cache memories of a processing unit 702, in other cache memories of device 700 (not shown), on other computer readable media, and so forth. Additionally, it is to be appreciated that the location where instructions are stored in device 700 can change over time.

One or more input/output devices 708 allow a user to enter commands and information to device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 7. The features of the threading together messages with multiple common participants techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a mobile communications device, the method comprising:
generating, for each message of a plurality of messages having three or more participants, a conversation identifier;
receiving a request to display a particular message of the plurality of messages;
identifying, in response to the request to display the particular message and based on the generated conversation identifiers, one or more other messages of the plurality of messages having a same conversation identifier as the particular message; and
displaying at least two of the one or more other messages of the plurality of messages concurrently.

2. A method as recited in claim 1, wherein generating the conversation identifier for a message comprises generating the conversation identifier based on participant identifiers of the three or more participants.

3. A method as recited in claim 1, wherein generating the conversation identifier for a message comprises generating the conversation identifier based on user identifiers of each of at least two of the three or more participants.

4. A method as recited in claim 1, wherein generating the conversation identifier for a message comprises generating the conversation identifier based on, for each of at least two of the three or more participants, a phone number, an email address, a mobile instant messaging address, or a social networking service address of the participant.

5. A method as recited in claim 1, wherein generating the conversation identifier for a message comprises generating the conversation identifier based at least in part on participant identifiers of the three or more participants except for a participant identifier of the mobile communications device.

6. A method as recited in claim 1, wherein the plurality of messages include two or more messages sent by the mobile communications device and two or more messages received by the mobile communications device from a plurality of other devices.

7. A method as recited in claim 1, wherein the displaying comprises concurrently displaying messages sent by three or more different devices, the three or more different devices including the mobile communications device, and each of the messages sent by the three or more different devices identifying the other of the three or more different devices as recipients of the message.

8. A method as recited in claim 1, wherein generating the conversation identifier for a message comprises:
obtaining, from the message, addresses of two or more participants in the message;
obtaining, for each of the two or more participants, a user identifier of a user associated with the address of the participant;
sorting the user identifiers to generate a set of sorted user identifiers; and
using a hash function to generate, based on the set of sorted user identifiers, a hash value to use as the conversation identifier for the message.

9. A method as recited in claim 1, wherein generating the conversation identifier for a message comprises:
obtaining, from the message, addresses of two or more participants in the message;
normalizing each of the addresses to a consistent representation, resulting in a set of normalized addresses;
converting the set of normalized addresses to a common length, resulting in a set of converted addresses;
sorting the set of converted addresses, resulting in a set of sorted addresses;
using a hash function to generate a hash value based on the set of sorted addresses; and
using the hash value as the conversation identifier for the message.

10. One or more computer storage media having stored thereon multiple instructions that, when executed by one or more processors of a mobile communications device, cause the one or more processors to:
obtain a message;
obtain, from the message, addresses of a plurality of participants identified in the message; and
generate, based on the addresses obtained from the message, a conversation identifier for the message.

11. One or more computer storage media as recited in claim 10, the instructions further causing the one or more processors to normalize one or more of the addresses by converting one or more of the addresses to a consistent representation.

12. One or more computer storage media as recited in claim 11, wherein one of the addresses is a phone number, and wherein to normalize the one address is to use a significant number of digits of the phone number as the one address.

13. One or more computer storage media as recited in claim 11, wherein one of the addresses is an email address or a mobile instant messaging address, and wherein to normalize the one address is to remove whitespace from the one address and convert letters in the one address to lower case.

14. One or more computer storage media as recited in claim 10, the instructions further causing the one or more processors to convert the addresses to a common length.

15. One or more computer storage media as recited in claim 14, wherein to convert the addresses to a common length is to use, for each of one or more of the addresses, a hash function to generate a hash value.

16. One or more computer storage media as recited in claim 10, the instructions further causing the one or more processors to sort the addresses prior to generation of the conversation identifier.

17. One or more computer storage media as recited in claim 10, wherein to generate the conversation identifier is to:
concatenate the addresses;
generate, based on the concatenated addresses, a hash value using a hash function; and
use the hash value as the conversation identifier.

18. One or more computer storage media as recited in claim 10, wherein each address comprises one of a phone number, a mobile instant messaging address, and an email address.

19. One or more computer storage media as recited in claim 10, wherein to generate the conversation identifier is to generate the conversation identifier based on the addresses of the plurality of participants identified in the message except for an address of the mobile communications device.

20. A method implemented in a mobile communications device, the method comprising:
obtaining a message that includes addresses of three or more participants to the message, the three or more participants including the mobile communications device and two or more other participants;
obtaining, from the message, an address of at least two of the three or more participants to the message;
normalizing each obtained address;
converting each of the normalized addresses to a common length, including generating, for each of the normalized addresses that exceeds a threshold length, a hash value for the normalized address;
sorting the converted addresses;
generating a conversation identifier for the message by generating a hash value of the sorted converted addresses; and
displaying the message concurrently with one or more other messages having the conversation identifier.
